(19) United States
(12) Patent Application Publication
(10) Pub. No.: US 2025/0053737 A1
(43) Pub. Date: Feb. 13, 2025

(54) Specialized Work Product

(71) Applicant: Story LLP Software Inc., Dover, DE (US)

(72) Inventor: Jessica Hubley, Atlanta, GA (US)

(73) Assignee: Story LLP Software Inc, Dover, DE (US)

(21) Appl. No.: 18/919,408

(22) Filed: Oct. 17, 2024

Related U.S. Application Data
(60) Provisional application No. 63/519,173, filed on Aug. 11, 2023.

(51) Int. Cl. G06F 40/20; G06F 16/23; G06Q 50/18

(52) U.S. Cl. CPC G06F 40/20; G06F 16/23; G06Q 50/18

(57) ABSTRACT

In one embodiment, a method to produce an automated work product is described. The method includes receiving a request from a user and analyzing the request to determine which area of expertise applies to the request. The method also includes assigning a scope identifier to the area of expertise and generating a work product based on the user request and the scope identifier associated with the request.

### CROSS REFERENCE TO RELATED PATENT APPLICATIONS

This patent application claims benefit of U.S. Provisional Patent Application No. 63/519,173 filed Oct. 18, 2023, and is incorporated herein by reference in its entirety for all purposes.

### BACKGROUND

Lawyers and attendant fees for legal services often constitute a large expense for businesses. Legal issues with significant monetary implications arise at all stages of a company's existence, from founding to exit or dissolution. However, the frequency and type of legal counseling a company may seek and obtain may not align with its actual need for legal representation. Companies or individuals may not obtain legal guidance for issues due to the cost of legal counsel or the difficulty of identifying an appropriate expert. Similarly, companies or individuals may not obtain other types of professional guidance, such as medical or accounting guidance, due to the cost or difficulty of finding an appropriately credentialed expert. In some cases, their failure to address legal issues adequately and efficiently may result in further legal liability or expense which may cause financial or undue duress. In some cases, the lack of other specialized professional advice may cause other harm.

Existing technology solutions may replace a billable lawyer's work by crudely automating standardized legal processes without reference to the needs or circumstances of a client. Automated legal document generation may create an official looking legal work product, but rarely delivers customization suited to the user's needs. A user without legal training or suitable legal experience may not ascertain whether the document is adequately configured for their needs. In this regard, a user may not hire a lawyer when they believe the document they purchased from an automated product provider properly applies to their situation, needs, and constraints. Moreover, the user may incorrectly complete or edit the automated document to suit their needs. Non-lawyer client users or inexperienced lawyers may rely upon over-standardized precedents because they misunderstand the specialized legal issues that apply. In such cases, the resulting inadequate or incomplete work product can result in costly mistakes and liabilities that may be difficult or impossible to reverse in the future.

Though they advance and evolve based on user input, generative AI and natural language processing tools available in the market are not structured to learn from or adapt to only qualified experts in a given subject matter. They are also not structured to weigh more accurate information and new developments, as is desirable for sciences and professional services, independently of administrator intervention. The existing systems do not improve accuracy by managing improvements and adjustments based on who has the credentials appropriate to make certain kinds of improvements and adjustments. By default, these systems will absorb biases and inaccuracies input by the any user, including the unsophisticated users, and weight them equally to the input of a subject matter expert. They have no means to determine who is a subject matter expert. Further, existing systems are not designed to distinguish nuances of natural language meaning that apply only in specific contexts or specializations, such as the particular legal definition of the word “fraud” in different legal jurisdictions.

Natural language processing systems which leverage, organize, or supplement generative AI and machine learning are often offered to experts for configuration to suit their personal application. They may use sophisticated methods of organizing or summarizing content for more efficient processing, for example through vectorization or intelligent chunking. Such systems often have the capacity to reference source materials but require the user to affirmatively identify and update the source materials or define the rules to reference the source materials. The scope of such a system is necessarily limited to the scope of the expertise of the user or customer, without practical means to identify relevant patterns outside of that scope in the way that two or more humans in conversation might each share and identify a pattern that neither could have identified alone.

Therefore, there is a need for improvements in methods to provide professional services, and especially legal services that deliver higher quality work product across varies areas of expertise than existing legal technology models and unspecialized natural language processing tools, but lower overall legal costs through automation. There is a further need for such automation to deliver accurate outputs with respect to a plurality of subject matters without the user having, or engaging someone who has, more types of expertise than any one human reasonably can. Combining the knowledge, logic and processes of a plurality of vetted and credentialed subject matter experts into one central processing system presents an opportunity to surpass the sophistication of systems that combine everyone's relative ignorance on the same subject matters indiscriminately, at least with respect to professional services which require licensed practice and adherence to professional standards. In this regard, the present disclosure provides systems and methods to enhance information discovery relevant to professional service provision and methods and systems of providing diverse legal services via centralized automated, or at least partiality automated, methods and systems.

### BRIEF SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present disclosure describes instances and examples of the generation, delivery, and improvement of specialized work product and devices, servers, datastores, user interactions, systems, and methods which operate together in a multi-expert, infinite context automated agent (the “MEICAA”).

In one embodiment, a method to produce an automated work product is disclosed. The method includes receiving a request from a user and analyzing the request to determine at least one area of expertise applicable to the request. The method also includes assigning a scope identifier to the at least one area of expertise and generating an output based on the user request and the scope identifier associated with the request.

In some embodiments, the output may be a specialized work product. In some embodiments, the specialized work product may be a legal work product. In some embodiments, the scope identifier may be associated with an area of law.

In some embodiments, the method may include receiving user input requesting output review and identifying at least one qualified reviewer for the requested output review. The method may also include receiving input from the at least one qualified reviewer and updating the output based at least in part on the input from the at least one qualified reviewer. In some embodiments, the method may include assigning a credibility score to the output and comparing the credibility score to an acceptable credibility score determined by the user.

In some embodiments, the method may include determining a review type of the output based on the comparison. The method may also include analyzing changes to the output and determining which changes were made by an authorized user. The method may update one or more databases when the changes are made by the authorized user. In some embodiments, the method may include rejecting one or more database updates when changes are not made by the unauthorized user.

In one embodiment, a method of training an artificial intelligence language model is disclosed. The method includes outputting, automatically, an original document from an original database. The method also includes analyzing changes to the original document and determining which changes are made by at least one authorized reviewer. The method additionally includes updating the original database when the changes are made by the at least one authorized reviewer.

In some embodiments, the method may receive credentials from a reviewer and analyze the credentials of the reviewer. The method may determine when the reviewer is an expert in a specific field and assign a scope identifier to the expert reviewer when the reviewer is an expert in the specific field. The method may include outputting an original document when an original request from a user is received. The method may analyze the original request from the user and assign an area of expertise to the request based at least in part on the analyzation. In some embodiments, the authorized reviewer may be an expert in the area of expertise assigned to the request.

In another embodiment, an apparatus for generating an output is described. The apparatus includes a processor, memory in electronic communication with the processor, and instructions stored in the memory and executable by the processor. The processor is programmed to cause the apparatus to receive a request from a user and analyze the request to determine an area of expertise applicable to the request. The processor is further programmed to assign a scope identifier to the area of expertise and generate an output based on the user request and the scope identifier associated with the request.

In some embodiments, the processor may be further programmed to receive user input requesting output review and identify at least one qualified reviewer for the requested output review. In some embodiments, the processor may be further programmed to receive input from the at least one qualified reviewer and update the output based at least in part on the input from the at least one qualified reviewer. In some embodiments, the output may be a specialized work product. In further embodiments, the specialized work product may be a legal work product. In some embodiments, the scope identifier may be associated with an area of law. In some embodiments, the processor may be further programmed to assign a credibility score to the output and compare the credibility score to an acceptable credibility score determined by the user. In some embodiments, the processor may be further programmed to determine a review type of the output based on the comparison. In some embodiments, the processor may be further programmed to analyze changes to the output, determine when changes are made by an authorized user, and update one or more databases when the changes are made by the authorized user

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a diagram of a sample MEICAA system in accordance with the present disclosure;

FIG. 2 is a block diagram of an example MEICAA system in accordance with one example of the present disclosure;

FIG. 3 is a block diagram of sample embodiments of components of a MEICAA module in accordance with one example of present disclosure;

FIG. 4 is a block diagram of sample embodiments of components of a MEICAA module in accordance with one example of present disclosure

FIG. 5 is a block diagram of sample embodiments of components of a MEICAA module in accordance with one example of present disclosure;

FIG. 6 is an exemplary flow diagram in accordance with embodiments of the present disclosure;

FIG. 7 is an exemplary flow diagram in accordance with embodiments of the present disclosure;

FIG. 8 is an exemplary flow diagram in accordance with embodiments of the present disclosure; and

FIG. 9 is a is a block diagram of an example device in accordance with one example of the present disclosure.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as precluding other embodiments. The illustrative examples provided herein are not intended to be exhaustive or to limit the disclosure to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The following specification describes a multi-expert, infinite-context automated agent (“MEICAA”) to produce a specialized work product that may better meet a requestor's needs and wants, at the quality expected from a highly experienced specialist, but at a lower cost. The MEICAA may leverage components and scopes applicable to those components to produce automated or partially automated outputs which may result in a tailored, legal work-product better suited to the requesting client's needs or lawyer's needs. The outputs of the MEICAA may be reviewed and improved by appropriately credentialed human reviewers, where such human reviewer may be identified with a scope identifier describing the scope of the human's expertise and authority. The MEICAA algorithm may implement a continuous learning model that updates its components based on qualified inputs from appropriately credentialed subject matter experts. For example, the MEICAA may continuously incorporate applicable learnings from only highly qualified personnel in the subject matter of their qualification, as opposed to a general population of unknown and uncertified skill and knowledge, without specific administrator or programmer intervention. Components leveraged by the MEICAA may include one or more of knowledge base(s), rules engine(s), and scope identifier(s).

In some embodiments, a knowledge base may be a repository of information of any type or format, which may be static or dynamic according to the character of the information it stores. A knowledge base may be a relational database, a knowledge graph, servers, databases, data centers, network-attached storage (NAS), storage area networks (SAN), or any other datastore on any device.

In some embodiments, a rules engine may define, constrain, process, instruct, limit, and otherwise guide part or all of the system operations, including without limitations one or more of: rules, algorithms, protocols, policies, configurations, parameters, settings, permissions, access controls, workflows, business logic, functions, procedures, methods, scripts, triggers, event handlers, state machines, validation rules, constraints, dependencies, conditionals, control structures, filters, directives, templates, blueprints, data schemas, data models, metadata, API specifications, encryption standards, authentication mechanisms, authorization frameworks, governance policies, error-handling routines, timeout policies, versioning rules, logging frameworks, monitoring tools, performance thresholds.

In some embodiments, a scope identifier may be a collection of data, markers, or a combination thereof which relate to a given scope and may allow for and enable the MEICAA to identify appropriate operations and effect appropriate updates. A scope identifier may be a unique identifier. A scope identifier may combine one or more items of information to define and reflect a scope. In one embodiment, a scope identifier may comprise a knowledge graph representation of the applicable scope which may be configured to consult other stored data as it is rendered or consulted. In some embodiments, the scope identifier may contain a unique identifying string, code, or hash such as a UUID or encryption key. In still further embodiments, the scope identifier may include the use or storage of encryption keys alongside other elements. In some embodiments, the scope identifier may contain a series of values in a relational database format. In some embodiments, a scope identifier may be reflected by a quantum state or any other means of marking or collecting data which may be referenced by the MEICAA.

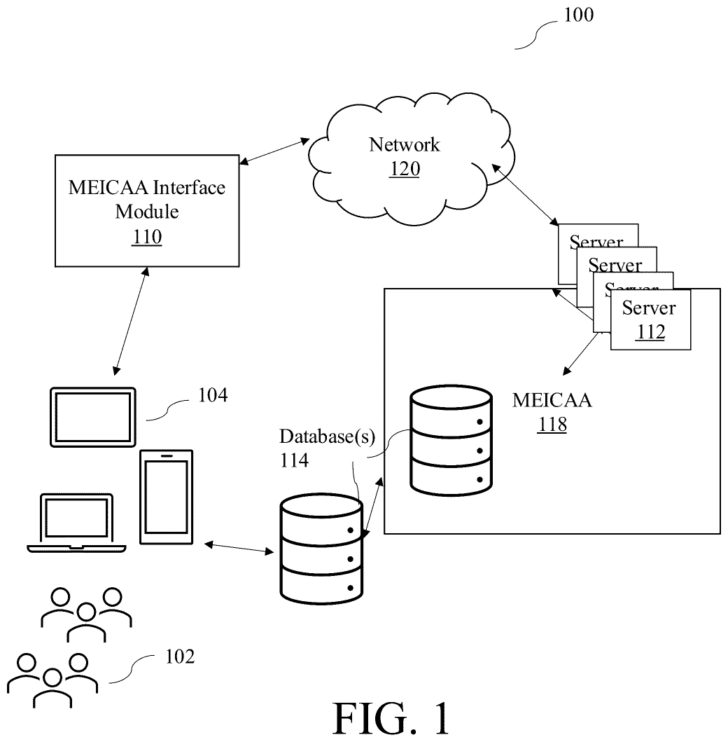

FIG. 1 is a block diagram illustrating one embodiment of an environment 100 in which the present systems and methods may be implemented. The environment 100 may include one or more users or consumers 102, one or more devices 104 associated with the users, one or more databases or servers 112, and a network 120 that allows the different parts of the environment 100 to communicate with one another.

Examples of the device 104 may include a mobile phone, a laptop, a desktop computer, a fablet, a tablet, mobile computing device, smart phone, personal computing device, computer, server, etc. The device 104 may allow a user 102 to connect with various components of the system. The device 104 may be display or otherwise interface with a MEICAA interface module 110. The MEICAA interface 110 may provide a proper interface to interact with the MEICAA 118 which may receive and direct processes and data in the environment 100. For example, a user 102 that is a potential client may interact with a client intake interface as an embodiment of the MEICAA interface 110, which may interacts with the MEICAA module 118 to build, modify, and otherwise operate scope identifier(s), knowledge base(s), or rules engine(s) for such user 102 and other users of the environment 100. A different qualified reviewer user may view a different MEICAA interface 110 as determined by the MEICAA 118.

In some embodiments, the MEICAA interface module 110 may be a local program application operable without any internet connection and may be solely contained to the device in which it is loaded. This may enable the user to input confidential and sensitive information without worry that the information may be on a public server that others may access. In other embodiments, the user 102 may use the device 104 to connect to the MEICAA interface module 110 via a webpage, application, or the like. In these embodiments, the MEICAA interface module 110 may enable connection to dedicated confidential and protected knowledge bases specific to the user 102 stored on the server(s) 112 as identified and accessed via the MEICAA 118. Likewise, the MEICAA module 118 may also have dedicated confidential and protected rules engine(s) specific to types of users or a particular user.

Examples of the server 112 may include a server administered by the operator of the MEICAA, by a third-party hosting company, on a virtual private cloud, by a user's device, or on other cloud storage. In some embodiments, the environment 100 may include a single server or multiple servers 112 as shown. The server(s) 112 may share data and resources with one another and third parties. In some embodiments, the server(s) 112 may host the MEICAA 118.

In some embodiments, the devices 104 may communicate with server(s) 112 via a network 120. Examples of a network 120 include cloud networks, local area networks (LAN), wide area networks (WAN), virtual private networks (VPN), wireless network, cellular networks (using 3G, 4G, and/or LTE, for example), etc. In some configurations, the network 120 may include the internet.

In some embodiments, server(s) 112 may be coupled to database 114. Database 114 may optionally include the MEICAA module 118. In still further embodiments, the device 102 may access the MEICAA module 118 via the server 112. Database 114 may be internal or external to the server 112. In one example, device 104 may be coupled directly to database 114, database 114 being internal or external to device 102. In another example, device 104 may be connected to database 114 via network 120 and server(s) 112. The MEICAA module 118 may comprise the software and data necessary to produce output work product tailored to the user's information, preferences, and legal needs as well as the means to review and provide feedback on such output work product.

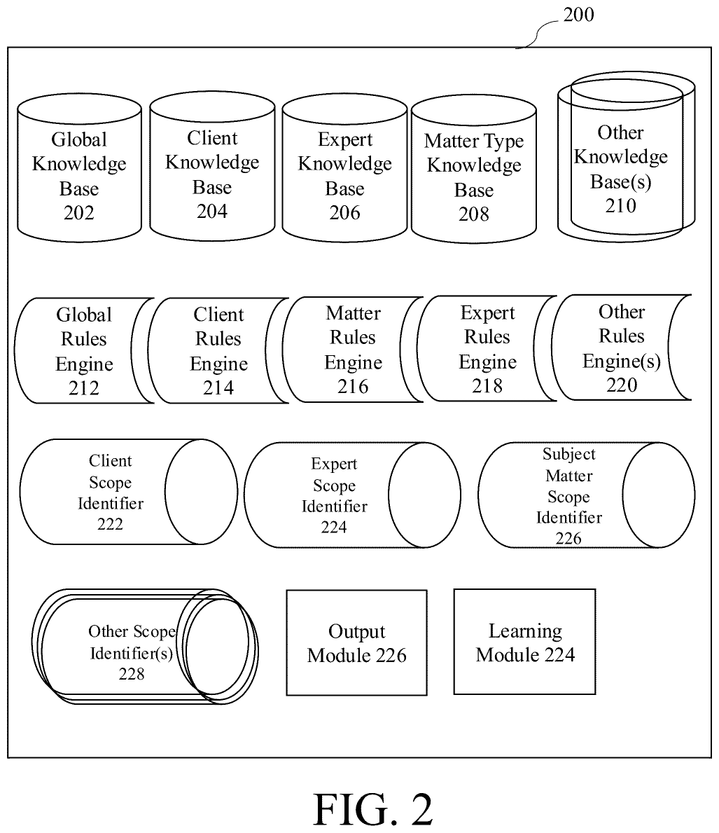

FIG. 2 is a block diagram illustrating components of one example of a MEICAA 200. In some embodiments, the MEICAA 200 may include a global knowledge base 202, a client knowledge base 204, an expert knowledge base 206, a matter type knowledge base 208, and other knowledge bases 210 as needed or necessary. The MEICAA 200 may also include a global rules engine 212, a client rules engine 214, a matter rules engine 216, an expert rules engine 218, and other rules engines 220 with other scopes. The MEICAA 200 may also include client scope identifier module 222, expert scope identifier module 224, subject matter scope identifier module 226, and other scope identifiers 228. The MEICAA 200 may also include a learning module 230 and an output module 232.

The MEICAA 200 may be comprised of relational databases, graph databases, other databases, files functions, algorithms, strings, configurations, source code, artificial intelligence (“AI”) language model(s) or series of such models, certain parameters of such models or maps thereof, or custom vectors and tuning on an existing artificial intelligence language model comprising a generalized language model, or other computer system elements. Such elements may alone, or in combinations with one another, serve as part or all of a rules engine, knowledge base, or connections there between. Such elements may alone, or in combinations with one another, may constitute a scope identifier.

The components of the MEICAA 200 may be implemented through a plurality of technical forms which may be used on one or more types of components, scope, or connective function. For example, a relational database, knowledge graph, or JSON Object may serve as a knowledge base in the MEICAA 200, and another relational database, knowledge graph and/or JSON Object may also serve as a scope identifier for that client in the MEICAA 200. As another example, a software algorithm may function as a rules engine or may define how a particular scope identifier is constructed and maintained. As another example, an artificial intelligence language model may be trained, tuned, or vectorized to serve as part or all of a rules engine or a knowledge base, or to take an input of a document and return data used to populate or operate any component. The interactions between components in the MEICAA 200 and the establishment of scope identifiers may be achieved through any known or later developed technical means. The MEICAA 200 may further use any technical means to implement rules, which may or may not in turn consult knowledge bases or scope identifiers, to assess whether a qualified human review with a given scope should occur, or should occur prior to modifying a component, and may use any means to obtain and ingest that review.

The global knowledge base 202 may comprise one or more knowledge bases, for example datasets, databases, knowledge graphs, web page code, text, or other collections of information associated with the entire scope of the MEICAA 200. For example, the full text of the United States Code may constitute a knowledge base of global scope for a MEICAA 200 applicable to United States law. A language model with the capability to generate text in English may constitute a knowledge base of global scope for a MEICAA 200 applicable to English-language work product.

In some embodiments, the global knowledge base 202 may include template documents and components thereof. These components may be base level templates with use cases across various types of legal matters. For example, there may be template components applicable to responses to all demand letters in English. In some instances, the “demand letter respond” template may be generic and apply as a best practice to most demand letter responses, such as a greeting or general reservation of additional claims.

In further embodiments, the global knowledge base 202 may also contain publicly available documentation or the ability to pull publicly available documentation. For example, the global knowledge base 202 may pull Securities and Exchange Commissions (SEC) filings that are publicly available. These filings may be treated as potential templates for future SEC contract requests by clients. They may be stored without a more specific scope identifier until such time as the MEICAA identifies an appropriately credentialed user to apply appropriate scope identifiers. In still further embodiments, the global knowledge base 202 may include legal treatises as well as relevant statues, rules and regulations and updates thereto. For some matters, court decisions may be ingested with global scope until they are later given one or more specific scope identifiers.

In some embodiments, the global knowledge base 202 may incorporate an identification and mapping of relationships between key data elements associated with a legal event, a legal issue, or existing legal work product having more specific scopes.

In some embodiments, the global knowledge base 202 may also include information on formatting rules. In some embodiments, the formatting rules may be generic legal document formatting rules.

In some embodiments, the global knowledge base 202 may include best practices. These best practices may be methods or techniques that have been generally accepted as the superior method to achieve desired results. This may include best practices related to when and how to carry out a task or configure a response or document. For example, the best practices may include the threshold for similarity of two scope identifiers required to authorize a particular type of update effected by the MEICAA.

In some embodiments, a client knowledge base 204 may contain prior drafts and final work products completed by a variety of specialists for a particular client. In some embodiments, the client knowledge base 204 may contain a clients entire legal file, components of that file transformed into different data types, and organized in various data stores, or a vectorization of either of these, etc. The MEICAA 200 may be specific to a single client or may contain an indefinite amount of client knowledge bases 204 relating to each specific client. In other embodiments, each MEICAA 200 may be specific to a specific client.

In some embodiments, a client knowledge base 204 may contain demographic information describing a client, such as their registered agent address, their incorporation date, the number of authorized shares currently in existence for the company, a person's home address, or other descriptive and demographic information about an individual or entity. In some embodiments, the client knowledge base 204 may contain information about an individual or entity's objectives, constraints, budgets, or other preferences. In other embodiments, the client knowledge base 204 may contain other information which describes an individual or entity, its environment, its circumstances, etc.

In some embodiments, the client knowledge base 204 may contain aggregate information about all clients' preferences, demographics, and other characteristics which is consulted by the MEICAA 200 in various processes. The client scope knowledge base 204 may comprise information associated with previous or current clients that have engaged with an entity managing the MEICAA 200 as discussed herein. The knowledge bases, datasets, or collections of information can be updated with changes in client circumstances or preferences where the feedback or inputs come from an appropriate client representative.

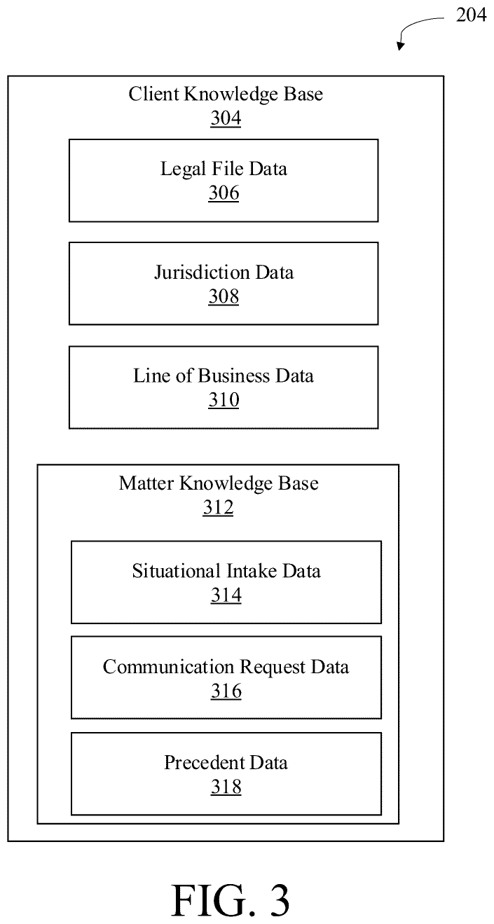

Referring now to FIG. 3, an exemplary client knowledge base 204 may include a client-specific knowledge base component 304 and matter-specific components(s) 312 which may contain information relating to a unique client and the matters applicable to that client, respectively. The client module 304 may include data about a company's legal file 306, jurisdiction 308, line of business 310, and a specific legal matter knowledge base 312. The matter knowledge base 312 may include data obtained during matter intake 314, data obtained from the client about their communication preferences 316, and a legal document precedent provided by the client 318.

Whereas the client knowledge base 204 has a scope identifier relating to all clients within the MEICAA 200, the client module(s) 304 may be individual modules created for each individual client. For example, the client knowledge base 304 may contain separate databases for each individual client.

In some embodiments, the legal file data 306 may contain incorporation documents specific to each client. The legal file data 306 may also store any other documentation specific to a client. For example, the legal file data 306 may include a certificate of incorporation, an entity name, bylaws and articles, any amendments made to the bylaws and articles, articles of organization, and the like. The legal file data 306 may contain share certificates and a record of the board of directors. If the client is an international client or performs business internationally, the jurisdiction data 308 may store the necessary information regarding the client's international locations as well as the locations in various U.S. states. In some embodiments, this may be information the client communicates to the client module 304. In further embodiments, the MEICAA 200 may regularly update the client knowledge base 304 with external information or information from other knowledge base(s), such as court filings, press releases, securities filings, etc.

In some embodiments, the matter knowledge base(s) 312 may be a component relevant to each matter the client has initiated which is known to the MEICAA 200, regardless of status. The situational intake data 314 may include request form submissions, documents, and other information about each matter. For example, the intake knowledge base 314 may have information submitted in a standard intake document and/or protocol to gather initial information. Information gathered may, in turn, cause the MEICAA 200 to identify more specific intake questions based on the matter scope identifier assigned, including potential jurisdictional information, additional documents received, etc. The intake data 314 and the matter knowledge base 312 may then be appended with such additional information. As the MEICAA 200 updates processes with appropriate client- or matter-related scope identifiers, it may initiate processes to update or prompt a user to update legal file data 306, intake data 314, line of business data 310, or other knowledge base(s) with an applicable scope.

In further embodiments, the intake data 314 or other segments of the knowledge base(s) may be appended with information obtained by or derived from a lawyer or other expert while supporting a client or handling a matter. In further embodiments, the intake data 314 or other segments of the knowledge base(s) may be appended with information obtained by or derived from the MEICAA's other automated or partially automated functions.

In some embodiments, a knowledge base such as the client knowledge base 304 or the matter knowledge base 312 and the communication request data 316 therein may inform the operation of rules engine(s) 212, 214, 218, 220. In some embodiments, the communication request data 316 may determine the timing in which the MEICAA 200 generates status update work product or how often client feedback is solicited on a particular type of work product.

In some embodiments, the precedent data 318 may store all matter documents in a repository. For example, in some embodiments, the precedent data 318 may have a scope identifier which overlaps with a specific area of law, type of matter, etc. In some embodiments, the precedent data 318 may not share any overlapping a scope identifier with any other specific area of law, type of matter, etc. known to the MEICAA.

In some embodiments, each knowledge base 304, 312 may have one or more nested layer of knowledge base, where each layer has an associated scope identifiers. The scope identifiers for each nested knowledge base may be the same, similar, overlapping, or unrelated. For example, the scope identifier for the client knowledge base 304 may comprise a knowledge graph database record created and queried in Cypher code; the scope identifier for the matter knowledge base 312 may comprise a different graph database record created and queried in Cypher code, and the two knowledge bases 304, 312 may contain any amount of overlapping or similar Cypher code. In some embodiments, the knowledge bases 304, 312 may only overlap with respect to a UUID assigned to the client. In other embodiments, the knowledge bases 304, 312 may overlap with respect to the majority of characters in the cypher code or knowledge graph. In other embodiments, the Cypher code reflecting the matter knowledge base 312 may appear in its entirety as a part of the client knowledge base 304.

Referring back to FIG. 2, each type of knowledge base within the MEICAA 200, whether global knowledge base 202, client knowledge base 204, expert knowledge base 206, matter type knowledge base 208, or other knowledge bases 210, may have sub-component knowledge basis with the same, similar, or overlapping scope identifiers. Such sub-component knowledge bases may be nested within one or more other sub-component knowledge bases of greater scope, or may relate or overlap with other knowledge base scopes and described herein.

In some embodiments, an expert knowledge base 206 may contain historic information about all experts or component knowledge base about a particular human expert, such as that expert's previous draft and final work product, academic credentials, work experience, historic transactions or litigations, etc. In some embodiments, an expert knowledge base 206 component relating to a specific expert or group of experts may contain demographic information about the expert(s), such as their age, gender, or ethnicity. Such information may prove relevant to assess or weight the expert's biases or project the likelihood that they will work well with a particular client or matter, for example. In some embodiments, an expert knowledge base 206 component relating to a specific expert or group of experts may contain information about the expert's preferences, such as formatting conventions, display preferences, preferred working hours, preferred vacations times, etc. In some embodiments, an expert knowledge base 206 component relating to a specific expert or group of experts may contain historic work product produced by the group of experts or specific expert, respectively.

In some embodiments, a subject matter knowledge base 208 may contain elements of work product related to that subject matter. For example, an employment or California employment knowledge base may contain the demand letter template language with a given summary of a particular employment or California employment law. In some embodiments, a subject matter knowledge base 208 may contain elements tailored to specific areas of the law-such as language responsive to a patent infringement demand. Other template components stored within a specific subject matters knowledge base 208 may apply to one or more other legal subject matters or requirements, such as non-disclosure agreements, business formation documents, commercial contracts and the like. The list of potential template subject matters is too numerous to list. Certain templates or template components may be applicable to more than one subject matter scope, or to one or more categories of subject matter.

In some embodiments, a subject matter knowledge base 208 may comprise a library of legal work product that has been assigned a scope identifier of the applicable subject matter by one or more qualified reviewer(s) or the MEICAA itself according to the methods to assign and identify scope identifiers discussed herein. The subject matter knowledge base 208 may comprise scope identifiers for a document type, a client profile, a negotiating position, and the like, each of which in turn may be associated with information such as a library of contract provisions which are associated with that subject matter scope.

In some embodiments, other knowledge bases 210 may be contained in the MEICAA. 200 Such knowledge bases 210 may include court rules and deadlines associated with a particular jurisdiction and be associated with a scope identifier reflecting such jurisdiction. For example, local court rules and deadlines may be contained in a variety of knowledge bases, include both domestic and foreign court systems as well as federal and state jurisdictions and foreign counterparts, each with a unique, similar, or overlapping scope identifier reflecting that jurisdiction. In some embodiments, such a knowledge base may also be a sub-component the global knowledge base 202.

In some embodiments, knowledge bases 210 may comprise a knowledge base with a scope identifier reflecting the overlap between two scopes. For example, a knowledge base scope may contain only the work product produced by a specific expert for a specific customer or client, or their preferred communication preference when working together.

The MEICAA 200 also includes one or more rules engine(s), including a global rules engine 212, a client rules engine 214, a matter rules engine 216, an expert rules engine 218, and other rules engine(s) 220.

In some embodiments, the global rules engine 212 may comprise one or more legal processes, standards, algorithms, or other types of rules as described herein. The global rules engine 212 may process or otherwise receive an input of certain data which in turn may automatically generate legal work product or a component of legal work product. The global rules engine 212 may further define conditions upon which certain work product should be presented to one or more qualified reviewers. For example, in some embodiments, the global rules engine 212 may require all legal work product for any client be presented to the client for review prior to presenting it to any party for signature. The global rules engine 212 may draw from external or internal MEICAA knowledge bases, such as a statutory code, court rules, and the like.

In some embodiments, the global rules engine 212 may be configured according to consultation with a knowledge base. For example, the global rules engine 212 may be updated with respect to statutory interpretation rules based on a court decision which addresses principles of statutory interpretation generally. In some embodiments, the global rules engine 212 may set a process to refer to the global knowledge base 202 for the execution of processes.

In some embodiments, the client rules engine 214 may contain and implement rules with a scope identifier relating to a specific client, all clients, to a combination of clients, or some combination thereof. In some embodiments, the client rules engine 214 may contain processes with relevance to addressing any client inquiry or a specific client's requests. In some embodiments, the client rules engine 214 may affect the generation of background materials for a lawyer's handling of their matter to contain details the client has affirmatively added repeatedly in the past.

In some embodiments, the client rules engine 214 may have a scope of all clients and may implement best practices for dealing with any client, such as means to increase the speed or rate of client payment. For example, in some embodiments, if a prior client matter involved a fact pattern similar to a current client query, the client rules engine 214 may identify and leverage facts or fact patterns that were relevant thereto in its processing functions. In some embodiments, a client rules engine 214 may include a sub-component rules engine which may be scoped to a particular client may alter processes based on unique circumstances or patterns specific to that particular client. The client rules engine 214 may also define protocols or processes to consult or analyze the client knowledge base 204, for example to generate estimates or timelines to handle the same or similar matters for similarly situated clients.

In some embodiments, the client rules engine 214 may require a work product be created according to a specific budget, format, or operating procedure applicable to all clients. In some embodiments, a sub-component rules engine of client rules engine 214 which relates to a particular client may require the work product be created according to a specific budget, format, or operating procedure applicable to that particular client. In some embodiments, the client rules engine 214 may define what procedure to follow in the event of a conflict between the client specific rules engine and the client rules engine 214.

In some embodiments, the client rules engine 214 may notify a client representative, a human supervisor, and/or a legal subject matter expert to review a given work product or process. For example, the client rules engine 214 may determine whether a client knowledge base includes sufficient information to generate an adequate work product or additional input is required.

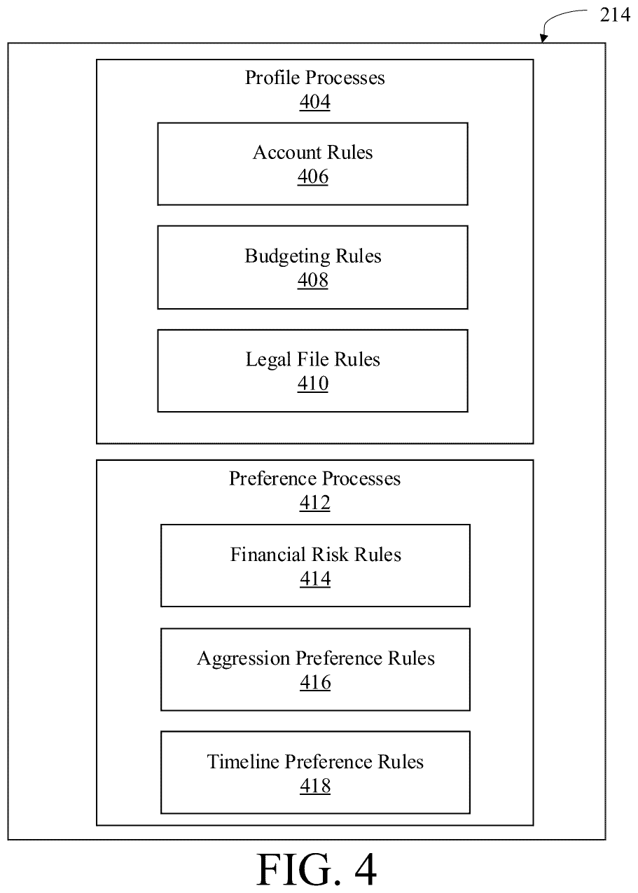

As shown in FIG. 4, in some embodiments, the client rules engines 214 may be an example of the client rules engine 214 discussed in relation to FIG. 2. The client rules component 214 may include a client profile process module 404 and a client preference module 412. In some embodiments, the profile process module 404 may include account rules 406, budgeting rules 408, and legal file rules 410. In some embodiments, the client preference module 412 may include financial risk rules 414, aggression preference rules 416, and timeline preference rules 418.

In some embodiments, the client process module 404 may define settings the client has requested relating to all work products. For example, the client process module 404 may include account rules 406 which may identify individual authorized signatories of the entity client or the job titles the client wishes to authorize to execute documents on its behalf. In further embodiments, the client profile process module 404 may include budgeting rules 408 which may define the circumstances under which the clients budget may increase and decrease, or an overall budget cap to be observed. In still further embodiments, the client profile process module 404 may include legal file rules 410 which define the processes identified by the clients legal file for taking an action like updating client bylaws.

In some embodiments, the client preference module 412 may outline various aspects of the client's preferences to consider when generating work product for that client. In some embodiments, the preference rules module 412 may relate to one individual or a number of individual users who fall within a given scope. In the case of client rules component 214 and the client preference process module 412, the preference module 412 may relate to a client generally or to various personnel if multiple personnel interact with the MEICAA 200 to provide inputs or request to review outputs. For example, some clients may have multiple in-house attorneys that have personal preferences in their formatting, documentation, communication style, and the like. The client preference module 412 may encode preferences which relate to tolerance for financial risk 414, to choosing an amount of aggression 416 in a given deal or type of deal, or for setting timelines 418 applicable to reviewing draft work product.

Each sub-component rules engine is associated with one or more scope identifiers. For example, in some embodiments, the financial risk rules 414 may govern the financial risk taken in making decisions on a single matter for the client. In other embodiments, the financial risk rules 414 may govern the budgeting for all matters ongoing with a client to provide an overall risk assessment score.

In some embodiments, the financial risk rules 414 may take an argument of a client's score of one to ten where one equals maximize risk and minimize cost, and ten equals minimize risk and maximize cost. The financial risk rules 414 may use the score to set the aggression preference rules 416 for a specific matter. In some examples, a client input of two might generate rules requiring low aggression to limit costly negotiations, whereas a client input of nine might trigger rules requiring high aggression such that work product include terms which must be negotiated heavily but which decrease the client's deal risk. In another example, the client's input score of two or nine or the like might be stored in the client's knowledge base to be consulted in the absence of a matter-specific input on cost versus risk preference in the future. Other client rules engines may determine when a stored score is ignored or used on future matters.

Returning to FIG. 2, the matter rules engine 216 may implement processes and protocols for generating work product, checklists, timelines, or other materials relevant to a category of matters or a particular matter. For example, the matter rules engine 216 may define the process to engage attorneys for a given matter. For example, in some embodiments, a sub-component matter rules engine with the scope of a manufacturing agreement may define the template contract provisions to be included in a client-friendly draft manufacturing agreement and the order in which to include them. In some embodiments, the matter rules engine 216 may update, modify, and/or enhance existing legal work product in the matter type knowledge base sub-component of 208 as appropriately credentialed reviewers make updates to work product of a similar matter scope, for example with similar factual basis and legal issue(s).

In some embodiments, the expert rules engine 218 may comprise sub-component rules engines relating to a group of experts and particular experts. The expert rules engine 218 may implement processes and protocols which are common to all experts. A subcomponent of the expert rules engine 218 relating to patent lawyers may implement processes and protocols relating to drafting patent applications, and a sub-component of that rules engine relating to a particular patent prosecution expert may implement processes and protocols relating to their individual preferred method of drafting patent applications.

In some embodiments, the expert rules engine 218 may execute rules to autonomously, or partially autonomously, generate, analyze, and respond to one or more aspects of a client matter with a comparable or overlapping scope identifier. In some embodiments, the expert rules engine 218 may update an expert knowledge base with a comparable or overlapping scope identifier when the nature of the work product inputs provided by such expert is deemed to require such an update.

In some embodiments, other rules engine(s) 220 may be contained in the MEICAA 200. For example, rules engine(s) 220 may include filing processes associated with a particular court or judge, or a process for drafting a particular kind of internal update, etc.

In some embodiments, rules engine(s) 220 may comprise a rules engine with a scope identifier reflecting the overlap between two scopes. For example, a rules engine scope may contain only the process mandated by specific expert for a specific customer or client, an implementation of their preferred communication timeline when working together.

In some embodiments, the MEICAA 200 may store a plurality of scope identifiers. For example, the MEICAA 200 may include a client scope identifier 222, an expert scope identifier 224, a subject matter scope identifier 226, and other scope identifiers 228. In some embodiments, the client scope identifier 222 may relate to all clients. In further embodiments, the client scope identifier 222 may relate specific clients or specific representatives of those clients. In some embodiments, the expert scope identifier 224 may relate to all experts and scope identifiers which relate only to specific experts or specific groups of experts. In further embodiments, the expert scope identifier 224 may relate to all experts and scope identifiers which relate only to specific experts or a specific groups of experts. In still further embodiments, the subject matter scope identifier 226 may relate to a given subject matter, and scope identifiers which relate subsets of the subject matter. IN some embodiments, the MEICAA 200 may include other scopes identifiers 228 which may relate to a particular document type, a particular court, a particular type of license or degree, etc.

In one embodiment, a specific legal specialty is a subject matter scope reflected by a scope identifier. The scope identifier for the legal specialty may comprise a hierarchy of nodes in a knowledge graph defined by Cypher code, wherein a series of unilateral relationships of “subspecialty-of” exist. The origin node may have a label with a category of legal practice such as “litigation,” “transactional,” or “regulatory.” In some embodiments, tach of these categories of legal practice, in turn, may have increasingly detailed sub-specialties. In some examples, nodes may be labeled “federal” and “state” which may have the relationship sub-specialty to the node with the label “litigation.” Similarly, in some examples, nodes may be labeled “Federal Circuit” or “Employment” which may have the relationship sub-specialty to the node with the label “federal,” and so on, such that there may be a number of levels of sub-specialty extending down to a particular document type.

In one embodiment, this document type may be a particular type of filing in a particular type of litigation in a particular court. In another embodiment, this document type may be a “certificate of incorporation” as a sub-specialty of “corporate governance,” which is in turn a sub-specialty of “corporate governance,” “corporate,” etc. A scope identifier may include an instance of this knowledge graph structure in which each node is assigned a property with a value of a Boolean (true or false) reflecting whether the label of a node is present. A legal matter, subject matter, legal expert, document type, or document may be represented by a scope identifier in wherein at least one of these Boolean values is “true.”

In one embodiment, only the most specific node in the hierarchy, the document type, applicable to the document type to be created in a given legal matter would be true for that legal matter. As defined by a global rules engine, an attorney's scope identifier may have a value of “true” for each document type they have produced one time, or only include a value of “true” only where that attorney had produced such a document more than ten times, for example. The global rules engine 212 may define the Booleans that may be assigned in such scope identifier knowledge graph, as well as defining which specific scope identifier knowledge graph and which properties therein would be deemed sufficient to match, overlap, or otherwise align with the scope of other rules engine(s) or knowledge base(s). For example, in some embodiments, identifying a subject matter expert having appropriate credentials to update the patent license agreement provision templates in a patent licensing subject matter knowledge base may include comparing the scope identifier of the expert to the scope identifier of a patent license agreement and confirming that each contained a value of “true” in the same locations of the legal specialty knowledge graph taxonomy.

In one embodiment, the scope identifier knowledge graph may reflect legal specialties. The scope identifier knowledge graph may include a dynamic structure which would evolve as new types of legal matters and documents were introduced to the MEICAA 200. The global rules engine 212 may define the process to affect such evolution.

In another embodiment, the MEICAA 200 may, for example, contain a globally-scoped rule dictating that where more than fifty experts with a scope identifier reflecting significant expertise in corporate governance have drafted the document type “certificate of incorporation” with the same provisions in the same order, that a legal matter request for a “certificate of incorporation” could be completed by the MEICAA 200 without a requirement to present draft work product to an expert for review.

In another embodiment, the scope identifier may be a series of values in a relational database. For example, the MEICAA 200 may create an “incorporation” matter type work product of “certificate of incorporation” by comparing the work product of experts with a particular configuration of values relating to corporate governance and identifying matters with work product entitled “certificate of incorporation” handled by such experts, then obtaining the documents output for such matters.

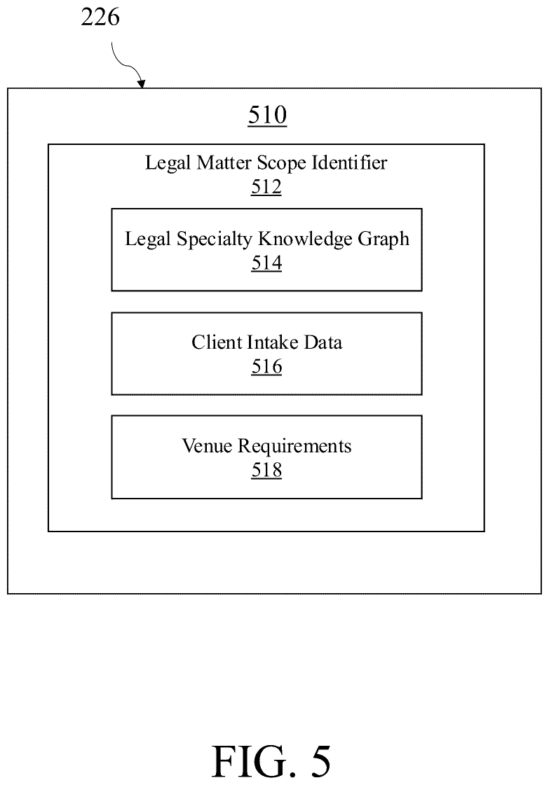

Referring to FIG. 5, the subject matter scope identifiers 226 may include a plurality of matter scope identifiers 510. The matter scope identifier may include multiple legal matter scope identifiers 512. Each legal matter scope identifier 512 may include, but is not limited to, a legal specialty knowledge graph 514, a client intake data module 516, and a venue requirements module 518. The client intake data module 516 may include information obtained stored in a relational database. IN some embodiments, the venue requirements module 518 may include venue requirements applicable to the matter reflected in a JSON object.

In some embodiments, the legal specialty knowledge graph 514 may use Booleans as the value of properties of nodes reflecting a given legal specialty or sub-specialty. The matter scope identifier 512 may allow for limited or infinite updating, referencing and parsing of sub-specialties or other sub-components associated with a comparable scope identifier to some extent, whether knowledge bases, rules engines, or other scope. In some embodiments, a scope identifier may only be updated by an administrator. In further embodiments, scope identifiers may be updated according to relationship, processes, and constraints defined in the MEICAA without human intervention.

In some examples, client intake data which is similar to, the same as, or overlapping with a scope identifier from a past matter may enable the MEICAA 200 to produce more customized legal work product for the applicable client based upon the client intake scope identifier elements of past matters known to the MEICAA 200 with the same legal specialty knowledge graph 514 or venue requirements 518. For example, in a given matter with a scope identifier similar to 512, the client may not understand, appreciate, or know the potential repercussions or avenues to pursue in choosing and drafting work product, and the lawyer best suited to support them may not have worked in the applicable venue before, but the MEICAA 200 may enable the client and lawyer to generate draft work product which is both customized to the client circumstances and the applicable venue. The venue requirements scope 518 may allow the MEICAA 200 to identify rules and knowledge based applicable to the venue and/or the applicable legal specialty. The client intake data 516 may allow the MEICAA to identify past work product and appropriately credentialed input applicable to that legal specialty, venue, and clients with the same or similar intake circumstances and profile. The MEICAA 200 may therefore produce a draft work product with relevant information than any client or attorney has the capacity to know or consider. The MEICAA 200 may produce a work product which may provide the client the benefit of historic data applicable to other clients, but does not waive the attorney client privilege of the past clients, reveal any of their confidential information to any person or external system, or create a conflict of interest to which a human lawyer representing parties in a similar subject matter and jurisdiction might be subject.

Referring back to FIG. 2, the expert scope identifier 224 may tag or code various subject matter expertise and experience of specialists or professionals interacting with the MEICAA 200. For example, the legal industry, as used herein for exemplary purposes only, has a vast array of subject matter and niche practice areas. To continuously improve the draft legal documents output by the MEICAA 200, the MEICAA 200 may continuously update its knowledge bases and rules engines. However, the MEICAA 200 may only update the knowledge bases and rules engines associated with that area of expertise when qualified and vetted contributors, as identified and tagged with an appropriate expert scope identifier 224, provide feedback. In this instance, each qualified contributor is vetted in a specific and select practice area or area of. For example, a patent attorney may only update documentation and subject matter related to patent law. The input provided by a patent attorney would be unable to update documentation and subject matter related to, for example, tax law or estate law. Further, patent law, used herein for exemplary purposes, has a vast array of niche practice areas. A patent attorney may be specialized in patentable subject matter cases, licensing, post grant review, etc. The patent attorney may also specialize in various subject matters such as pharmaceuticals or mechanical devices. These practice areas, while under the overarching umbrella of patent law, can have vastly different expertise. The specific experts scope identifiers may verify and vet each of the lawyers for not only an overarching broad subject matter, but also ancillary and niche practice area, when applicable to a specific legal matter or user request.

The expertise scope identifier 224 may implement various other subcategories as pertinent to allow the scope identifier of the legal subject matter related to an attorney, matter, document, event, asset, stakeholder, etc. to cover a wide variety of legal topics. The number and type of categories may vary. The expert scope identifier 224 may maintain a consistent scope identifier to code or tag legal work product, generate training data sets, or to identify the legal subject matter expertise of legal professionals interacting with the system. The expert scope identifier 224 may also update the categories or practice areas to accommodate new or previously unrecognized categories of specialties. The expert scope identifier 224 may incorporate more granularity or specificity to existing categories or create new categories or specialties as the law changes.

In some embodiments, the MEICAA may include a learning module 224. The learning module 224 implements rules and standards for how to update the MEICAA 200 itself. For example, the scope identifier applicable to a particular legal professional in the legal specialty knowledge graph example above might be updated with a “true” value for a new document type after their review results in accepted changes to that type of document for several matters with high client satisfaction ratings or no further expert edits. A global rules engine in the MEICAA might identify the standards to be consult a global or document type scoped knowledge base to identify whether the applicable criteria had been met with each review.

In some embodiments, a human expert scope identifier may store a lawyer's or other professional qualifications as well as client or customer reviews. This may enable a user of the system to not only obtain a draft document but to review a select list of professionals that have been vetted and matched to their needs by assessing overlapping scope and the level of expertise appropriate to a given matter. This may aid an individual or user to down select form the vast array of professionals to a select few knowingly qualified for their needs.

The output module 226 may incorporate the information from the global knowledge base 202, the client knowledge base 204, and the matter type knowledge base 208 and apply to such data rules from the global rules engine 212, the client rules engine 214, and the matter type rules engine 216, each such knowledge base and rules engine having a scope identifier of sufficient similarity to the scope identifier of the work product request, to generate specialized work product output. These components may generate a work product for the client or attorney to finalize and/or edit. In some embodiments, the output module 226 may not have sufficient information to produce a document or work product. For example, the work product may not exist in its databases, or the client request may be so unique that a standard template may not be tailored to their needs. In some instances, the output module 226 may need information from a third party, such as financial records. In some embodiments, the MEICAA 200 may generate a request for the information directly to a third party and, following fulfillment of the request, incorporate the necessary information in a final work product. The output module 226 may request permission from a client or lawyer, or a queried party may, separately and independently, request permission from another reviewer or an appropriately credentialed reviewer who is unknown to them.

In some embodiments, the output module 226 may generate an output for the client or lawyer which may, for example, be a draft an email, a communication, a dictated response to a query, and any similar work product the MEICAA 200 deems necessary. In some embodiments, the MEICAA 200 may determine a review of the draft is required prior to output, execution, etc.

In some embodiments, the output module 226 may generate a confidence measurement associated with the quality of a legal work product. The generated confidence level may identify a degree of confidence for a generated legal work product that is present or required to determine a next action, such as sending a document for signature or a particular type of review. In some embodiments, the generated confidence level may be bifurcated between legal and non-legal aspects. For example, a generated legal work product may have a higher level of confidence in the form (e.g., correct spellings, paragraph form, formatting, etc.) of the legal work product but a lower level of confidence in the substantive legal content of the output. A level of confidence for each of the types of content present in a legal work product generated by the output module 226 can be pre-determined as acceptable to any or all of the client, a legal professional to whom the client query might be assigned, or the system.

In some embodiments, if a generated confidence level for the form is below a pre-determined baseline, the legal work product and any associated client information, the output module 226 may request a human review thereof. In some embodiments, the output module 226 may flag specific areas to review such corrections, modifications, or enhancements to the word choice, paragraph form, formatting, etc. In some embodiments, the output module 226, through the confidence level, may determine the work product does not adequately address the substantive legal issues. This may require the production output module 226 to flag the work product for human review prior to delivering a document to a client.

In some embodiments, the MEICAA 200 may include a learning module 224. The learning module 224 may receive updates to be processed by the MEICAA 200 according to applicable rules. For example, if the tax code is an external knowledge base incorporated into the MEICAA 200 in the form of strings parsed into vectors and organized through variables reflecting cross references between code sections, the passage of a law which amends the tax code would be (1) received by the learning module 224, (2) identified as relating to the tax code knowledge base by virtue of the a subject matter scope identifier reflecting the tax code, (3) processed by rules engine(s) applicable to legislation amendments, tax code amendments specifically, etc., to update the applicable strings and the vectors, chunks, and variables that constitute the current tax code scoped knowledge base. As another example, if an employment specialist whose expert scope identifier overlaps appropriately with a Missouri employment expertise scope identifier updates a draft employment agreement for a Missouri, the learning module 224 would receive a signal through the MEICAA 200 to update the relevant section of knowledge bases containing contract provisions which related to Missouri employment agreements.

In some embodiments, the learning module 224 may be triggered by outside circumstances themselves or an expert's implementation of changes to outside processes, in each case using scope identifiers to determine whether changes to MEICAA 200 rules engines, knowledge bases, or fingerprints are warranted. For example, the USPTO may publish new guidelines for drafting patent applications. A patent attorney, reviewing a draft patent document, may update the document based on these guidelines and her own interpretation of the best practices it implicates. The learning module 224 may then determine what changes were made to the legal work product and who made the changes. Once the person who made the changes is identified, the learning module 224 may communicate with the expert identifier module 220 to determine if that person is a qualified expert. If the person is a qualified expert, the learning module 224 may then communicate with the appropriate knowledge bases and rules engine to implement changes to the MEICAA 200. In the example of a patent application guideline issued by the USPTO, a knowledge base scoped to reflect patent application guidelines would be adopted by the learning module in light of such an update to the USPTO guidelines because the patent office would always have sufficient expertise to warrant updating its own guidelines; however, a first year attorney without specific patent drafting experience would not have a scope identifier sufficient to qualify for determining patent application drafting best practices.

In some embodiments, the learning module 224 may fully or partially automate updates to the MEICAA 200. For example, the learning module 224 may review information from the any of the scope identifiers 222, 224, 226, 228 prior to updating any information in the MEICAA module 200. In this regard, the learning module 224 may limit updates or alterations to the MEICAA 200. This can help prevent reconfiguration of expert training that was used to configure the MEICAA 200. Such limits on modifications to the functionality of the MEICAA 200 may also substantially prevent, or at least reduce the possibility of, modifications or changes being made to previous expert coding or tagging of knowledge present in the knowledge base and rules present in the rules engine.

The learning module 224 may be a singular module as displayed or may be broken into various learning modules attached to the other components of the MEICAA 200.

In another example, the changes to a work product made by a reviewer may be more client focused. The learning module 224 may poll the client scope identifier 222 to determine if the changes were made by a qualified client personnel. If this is confirmed, the learning module 224 may then communicate with the appropriate client knowledge base 204 and client rules engine 214 to update the MEICAA 200 with regards to the qualified client personnel.

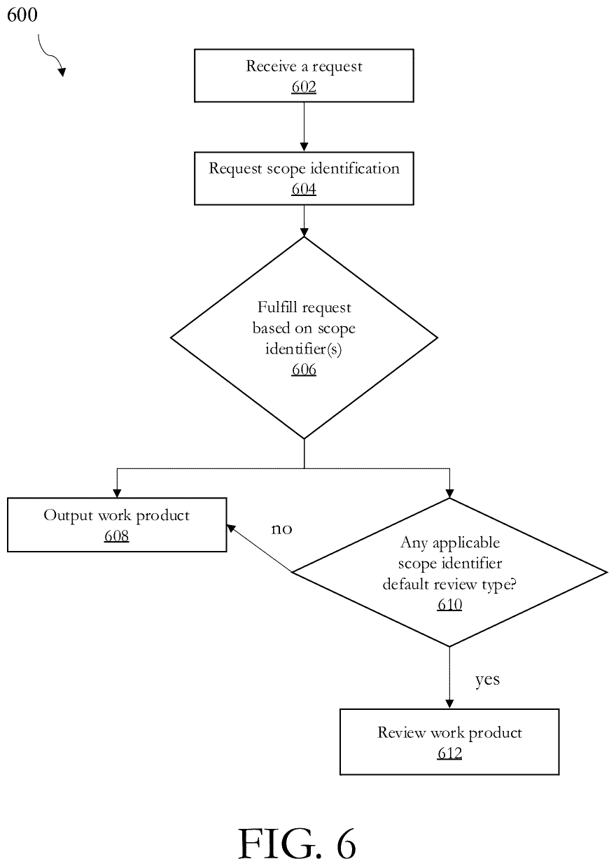

FIG. 6 is a flow chart illustrating an example of a method 600 for generating a legal work product, in accordance with various aspects of the present disclosure. For clarity, the method 600 is described below with reference to aspects of one or more of the systems described herein.

At block 602, the method 600 may receive a request. Then, at block 604, the method 600 may request a matter analysis and the application of a scope identifier to the new matter. At block 606, the method 600 may determine a matter scope identifier is applicable to the request or may assign a scope identifier to the request. In some embodiments, the MEICAA may determine how to fulfill the request. In some embodiments, the method 600 may also include, for example, identifying a confidence score to the fulfilled request or identifying any additional input necessary or desirable to fulfill the request. If a scope identifier is applied to the request and work product is created by the MEICAA, the method 600 may define a matter scope identifier.

In some embodiments, the method 600 may determine if the matter requires feedback from a qualified expert in order produce work product of sufficient quality according to the rules which define acceptable quality. At block 610, the method 600 may assess whether any of the scope identifier(s) applicable to the request are associated with a required review. For example, the method 600 may determine insufficient precedents were present in the scope identifier's applicable knowledge base to provide draft work product to anyone without appropriate credentials to assess its quality. As another example, the method 600 may determine the work product has a high confidence of being applicable to the known client needs and the matter type and determine that work product may be delivered directly to the client. As another example, the method 600 may determine any draft work product with the present scope identifier should be reviewed by a client, a certain expert scope, etc.

At block 608, if no review is desired for the applicable work product, the method 600 may fulfill the request with the fully-automated specialized work product. If a review has been requested, at block 612, the method 600 will initiate an applicable work product review.

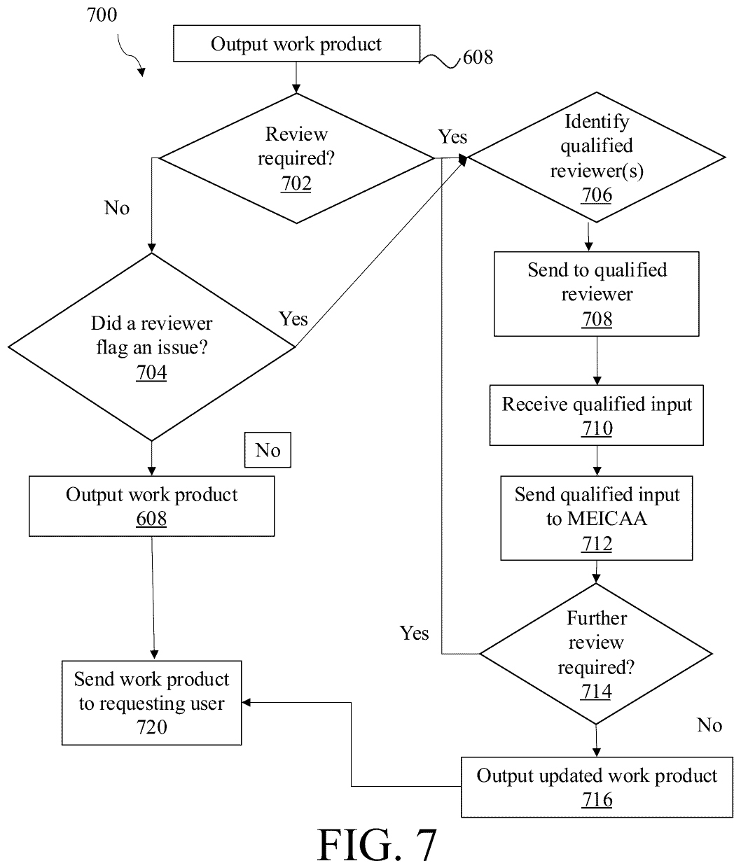

FIG. 7 is a flow chart illustrating an example of a method 700 for establishing and executing the necessary review for, and effecting review and updates to, draft legal work product output by the MEICAA in accordance with various aspects of the present disclosure. For clarity, the method 700 is described below with reference to aspects of one or more of the systems described herein.

At block 608, the method 700 may be initiated with the work product output. At block 702, method 700 may determine of which reviewers are required to conduct a review of the work product given its scope identifier. For example, if a client requested that they review all drafts before any lawyer or other party sees such drafts, the client would be identified as a required reviewer. As another example, if the scope identifier of the matter always requires expert review, or always requires lawyer review, or always requires client review, or always requires a combination of these, the method 700 may initiate such required review in an order defined by appropriately scoped rules engine(s) in the MEICAA.

If the method 700 does not require a review, at block 704, the method may identify whether any reviewer, whether or not required, human or automated, has flagged an issue with the draft work product output. If no reviewer has flagged an issue, the output work product may be delivered to the target user via a network and device. If any reviewer has flagged an issue, at block 706, the method 700 may identify qualified reviewer(s).

If the method 700 does require a review for any reason other than a user flagging an issue, the method 700 may require one or more qualified reviewers. For example, if a brief is to be filed in a court, a lawyer licensed in that court may always be required to review a brief drafted using automated means according to local rules,

Following the identification of qualified reviewers, at block 708, the method 700 may transmit the current iteration of the work product to one or more qualified reviewers with a request for qualified input. At block 710, the method 700 may receive qualified input by the qualified reviewer. At block 712, the method 700 may transmit the qualified reviewer's input to the MEICAA for further processing. For example, in some embodiments, the MEICAA may update a knowledge base of similarly scoped templates. At block 714, the method 700 may analyzes whether any further review is required. If more analysis is required, the method 700 may begin the process again at block 706. This process reiterates until, at block 714, the method 700 determines no further review is required.

After no further review is required, at block 718, the method 700 output updated work product to be made available to the end user. In some embodiments, the end user may view the work product on a device. In some embodiments, the resulting work product will be used to initiate another process, such as a government filing or signature collection.

In some embodiments, the method 700 may also assess a confidence score for the work product. The score may be a sliding scale which may allow a user to select an appropriate confidence score as a part of qualified input. Depending on the work product confidence score, whether according to a threshold determined by the MEICAA, the expert, or the client, or otherwise, the document may be sent for qualified review accordingly beginning within the method 700.

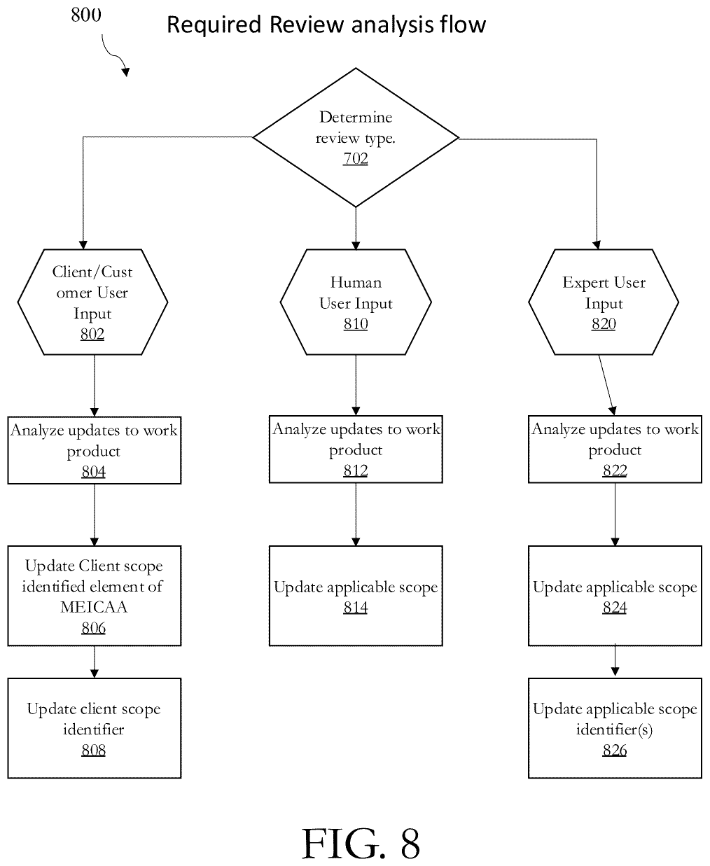

FIG. 8 is a flow chart illustrating an example of a method 800 for orchestrating reviewing an output work product. The method 800 may be an additional embodiment of block 702 of FIG. 7. For clarity, the method 800 is described below with reference to aspects of one or more of the systems described herein.

At block 702, the method 800 may determine a review type and reviewer. At block 802, the method 800 may determine the work product requires client/customer user input. The method 800 may then send the document to the client, who has a scope identifier commensurate with the work product. After the client makes any necessary changes, at block 804, the method 800 may update elements of the MEICAA which have a scope identifier associated with the client. For example, the method 800 may update the client legal file or information about the client's stakeholders in a database.

At block 808, if the work product updates or the client inputs are determined by the MEICAA to warrant changes to the client scope identifier itself, the method 800 may affect such changes as are deemed appropriate.

At block 810, the method 800 may determine human user input is desired and/or required, without specifying any credential or qualification for such human reviewer. At block 812, the method 800 may analyze the updates to the work product. For example, the method 800 may determine which changes were made to the document. The method 800 may then determine if these changes should be updated the context of any scope identifier, for example in the global knowledge base. If the updates warrant changes to any scope identifier's associated components, then at block 814, the method 800 may update the applicable components.

At block 820, the method 800 may determine expert user review is required and/or requested. The method 800 may route the work product to a qualified expert. The expert may be qualified and certified according to the application of a scope identifier.

At block 822, the method 800 may analyze the updates to the work product. The method 800 may determine if the changes to the work product should be made for any scope identifier(s), such as a matter type scope identifier or a specific matter scope identifier. At block 824, the method 800 may then update one or more components with applicable scopes. At block 826, the method 800 may update certain scope identifiers. For example, if an appropriately credentialed expert indicated during review that the work product should be a different document type or an additional document type is required for such a matter scope, the method 800 may perform commensurate updates.

Thus, the method 800 may provide for one method of providing a legal work product. It should be noted that the method 800 is just one implementation and that the operations of the method 800 may be rearranged or otherwise modified such that other implementations are possible.

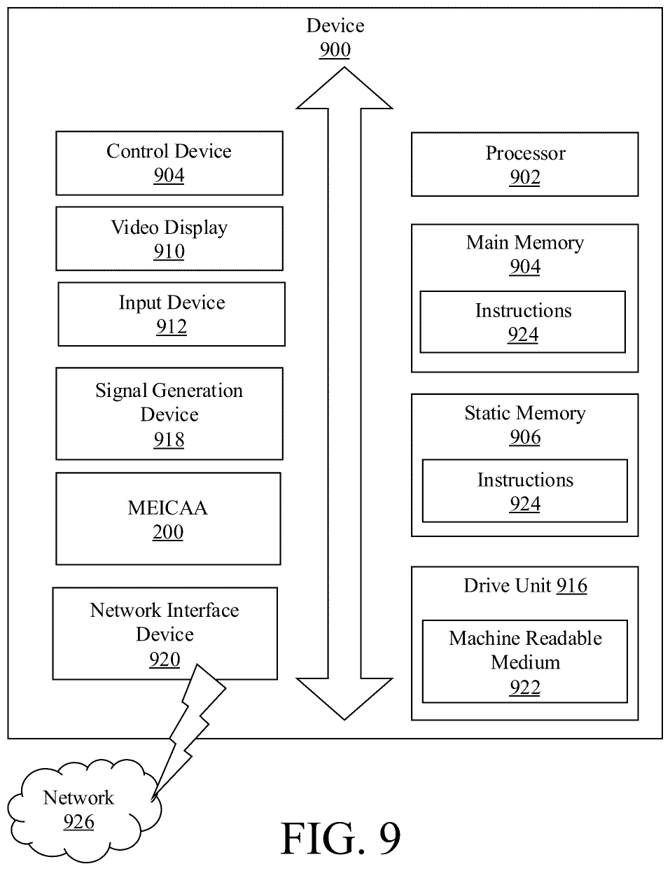

FIG. 9 is a diagram displaying various components of an example device 900. The device 900 may include a set of instructions causing the device 900 to perform any one of more of the methodologies described herein. In some embodiments, the device 900 may be an example of devices 104 as shown in FIG. 1. In alternative embodiments, the device 900 may operate as a standalone device or may be connected (e.g., networked) to other machines. In a networked deployment, the device 900 may operate in the capacity of a server or a client machine in server-client network environment, or as a peer machine in a peer-to-peer (or distributed) network environment. The device 900 may be a server computer, a client computer, a personal computer (PC), a tablet PC, a set-top box (STB), a Personal Digital Assistant (PDA), a cellular telephone, a web application, a network router, switch or bridge, or any machine capable of executing a set of instructions (sequential or otherwise) that specify actions to be taken by that machine. Further, while only a single device 900 is illustrated, the term “machine” shall also be taken to include any collection of machines that individually or jointly execute a set (or multiple sets) of instructions to perform any one or more of the methodologies discussed herein.

The device 900 includes one or more processors 902(s) (e.g., a central processing unit (CPU) graphics processing unit(s) (GPU) or both), main memory 904 and static memory 906, which communicate with each other via bus(s) 908. The device 900 may further include a video display unit(s) 910 (e.g., a liquid crystal display (LCD) or a cathode ray tube (CRT)). The device 900 also includes one or more of alphanumeric input device(s) 912 (e.g., a keyboard), cursor control device(s) 914 (e.g., a mouse), disk drive unit(s) 916, signal generation device(s) 918 (e.g., a speaker) and network interface device(s) 920.

The disk drive unit 916 includes a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the device 900, the main memory 904 and the processor 902 also constituting machine-readable media.

The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

A person skilled in the art will be able to practice the present invention after careful review of this description, which is to be taken as a whole. Details have been included to provide a thorough understanding. In other instances, well-known aspects have not been described, in order to not obscure unnecessarily this description.

Some technologies or techniques described in this document may be known. Even then, however, it is not known to apply such technologies or techniques as described in this document, or for the purposes described in this document.

This description includes one or more examples, but this fact does not limit how the invention may be practiced. Indeed, examples, instances, versions or embodiments of the invention may be practiced according to what is described, or yet differently, and also in conjunction with other present or future technologies. Other such embodiments include combinations and sub-combinations of features described herein, including for example, embodiments that are equivalent to the following: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In general, the present disclosure reflects preferred embodiments of the invention. The attentive reader will note, however, that some aspects of the disclosed embodiments extend beyond the scope of the claims. To the respect that the disclosed embodiments indeed extend beyond the scope of the claims, the disclosed embodiments are to be considered supplementary background information and do not constitute definitions of the claimed invention.

In this document, the phrases “constructed to”, “adapted to” and/or “configured to” denote one or more actual states of construction, adaptation and/or configuration that is fundamentally tied to physical characteristics of the element or feature preceding these phrases and, as such, reach well beyond merely describing an intended use. Any such elements or features can be implemented in a number of ways, as will be apparent to a person skilled in the art after reviewing the present disclosure, beyond any examples shown in this document.

Incorporation by reference: References and citations to other documents, such as patents, patent applications, patent publications, journals, books, papers, web contents, have been made throughout this disclosure. All such documents are hereby incorporated herein by reference in their entirety for all purposes.

Parent patent applications: Any and all parent, grandparent, great-grandparent, etc. patent applications, whether mentioned in this document or in an Application Data Sheet (“ADS”) of this patent application, are hereby incorporated by reference herein as originally disclosed, including any priority claims made in those applications and any material incorporated by reference, to the extent such subject matter is not inconsistent herewith.

Reference numerals: In this description a single reference numeral may be used consistently to denote a single item, aspect, component, or process. Moreover, a further effort may have been made in the preparation of this description to use similar though not identical reference numerals to denote other versions or embodiments of an item, aspect, component or process that are identical or at least similar or related. Where made, such a further effort was not required, but was nevertheless made gratuitously so as to accelerate comprehension by the reader. Even where made in this document, such a further effort might not have been made completely consistently for all of the versions or embodiments that are made possible by this description. Accordingly, the description controls in defining an item, aspect, component or process, rather than its reference numeral. Any similarity in reference numerals may be used to infer a similarity in the text, but not to confuse aspects where the text or other context indicates otherwise.

The claims of this document define certain combinations and subcombinations of elements, features and acts or operations, which are regarded as novel and non-obvious. The claims also include elements, features and acts or operations that are equivalent to what is explicitly mentioned. Additional claims for other such combinations and subcombinations may be presented in this or a related document. These claims are intended to encompass within their scope all changes and modifications that are within the true spirit and scope of the subject matter described herein. The terms used herein, including in the claims, are generally intended as “open” terms. For example, the term “including” should be interpreted as “including but not limited to,” the term “having” should be interpreted as “having at least,” etc. If a specific number is ascribed to a claim recitation, this number is a minimum but not a maximum unless stated otherwise. For example, where a claim recites “a” component or “an” item, it means that the claim can have one or more of this component or this item.

In construing the claims of this document, the inventor(s) invoke 35 U.S.C. § 112 (f) only when the words “means for” or “steps for” are expressly used in the claims. Accordingly, if these words are not used in a claim, then that claim is not intended to be construed by the inventor(s) in accordance with 35 U.S.C. § 112 (f).

What is claimed is:

1. A method to produce an automated work product, the method comprising:
receiving a request from a user;
analyzing the request to determine at least one area of expertise applicable to the request;
assigning a scope identifier to the at least one area of expertise; and
generating an output based on the user request and the scope identifier associated with the request.

2. The method of claim 1, wherein the output is a specialized work product.

3. The method of claim 2, wherein the specialized work product is a legal work product.

4. The method of claim 3, wherein the scope identifier is associated with an area of law.

5. The method of claim 1, further comprising:
receiving user input requesting output review;
identifying at least one qualified reviewer for the requested output review;
receiving input from the at least one qualified reviewer; and
updating the output based at least in part on the input from the at least one qualified reviewer.

6. The method of claim 1, further comprising:
assigning a credibility score to the output; and
comparing the credibility score to an acceptable credibility score determined by the user.

7. The method of claim 6, further comprising:
determining a review type of the output based on the comparison.

8. The method of claim 1, further comprising:
analyzing changes to the output;
determining which changes were made by an authorized user; and
updating one or more databases when the changes are made by the authorized user.

9. The method of claim 8, further comprising:
rejecting one or more database updates when changes are not made by the unauthorized user.

10. A method of training an artificial intelligence language model, the method comprising:
outputting, automatically, an original document from an original database;
analyzing changes to the original document;
determining which changes are made by at least one authorized reviewer; and
updating the original database when the changes are made by the at least one authorized reviewer.

11. The method of claim 10, further comprising:
receiving credentials from a reviewer;
analyzing the credentials of the reviewer;
determining when the reviewer is an expert in a specific field; and
assigning a scope identifier to the expert reviewer when the reviewer is an expert in the specific field.

12. The method of claim 11, further comprising:
outputting an original document when an original request from a user is received.

13. The method of claim 12, further comprising:
analyzing the original request from the user; and
assigning an area of expertise to the request based at least in part on the analyzation.

14. The method of claim 13, wherein the authorized reviewer is an expert in the area of expertise assigned to the request.

15. An apparatus for generating an output, comprising:
a processor;
memory in electronic communication with the processor; and
instructions stored in the memory and executable by the processor to cause the apparatus to:
receive a request from a user;
analyze the request to determine an area of expertise applicable to the request;
assign a scope identifier to the area of expertise; and
generate an output based on the user request and the scope identifier associated with the request.

16. The apparatus of claim 15, wherein the processor is further programmed to:
receive user input requesting output review;
identify at least one qualified reviewer for the requested output review;
receive input from the at least one qualified reviewer; and
update the output based at least in part on the input from the at least one qualified reviewer.

17. The apparatus of claim 15, wherein the output is a specialized work product.

18. The apparatus of claim 15, wherein the specialized work product is a legal work product.

19. The apparatus of claim 18, wherein the scope identifier is associated with an area of law.

20. The apparatus of claim 15, wherein the processor is further programed to:
assign a credibility score to the output; and
compare the credibility score to an acceptable credibility score determined by the user.

21. The apparatus of claim 20, wherein the processor is further configured to:
determine a review type of the output based on the comparison.

22. The apparatus of claim 15, wherein the processor is further configured to:
analyze changes to the output;
determine when changes are made by an authorized user, and
update one or more databases when the changes are made by the authorized user.
